(19) United States
(12) Patent Application Publication
(10) Pub. No.: US 2025/0143350 A1
(43) Pub. Date: May 8, 2025

(54) TEXTURIZED VEGETABLE PROTEIN

(71) Applicant: DSM IP Assets B.V., Heerlen (NL)

(72) Inventors: Arjen SEIN, ECHT (NL); Linda DE LANGE, ECHT (NL)

(21) Appl. No.: 18/839,700

(22) PCT Filed: Feb. 16, 2023
(86) PCT No.: PCT/EP2023/053838

§ 371 Date: Aug. 19, 2024

(30) Foreign Application Priority Data
Feb. 21, 2022 (EP) 22157747.1

(51) Int. Cl. A23J 3/22; A23J 3/14; A23J 3/26

(52) U.S. Cl. CPC A23J 3/227; A23J 3/14; A23J 3/26

(57) ABSTRACT

The invention relates to a dry extrusion process for preparing a texturized vegetable protein, to a composition comprising rapeseed protein, a legume-derived protein, and a plant-based fiber, to the use of said composition in the preparation of a meat alternative and to meat alternatives.

### FIELD OF THE INVENTION

The invention relates to a process for preparing a texturized vegetable protein, to a composition comprising rapeseed protein, a legume-derived protein, and calcium, to the use of said composition in the preparation of a meat alternative and to meat alternatives.

### BACKGROUND OF THE INVENTION

Proteins are an essential element in animal and human nutrition. Meat, in the form of animal flesh and fish, are the most common sources of high protein food. The many disadvantages associated with the use of animal-derived protein for human consumption, ranging from acceptability of raising animals for consumption to the fact that such meat production is inefficient in terms of feed input to food output and carbon foot print, makes the ongoing search for improved meat alternatives one of the most active developments in present day society.

Historically, meat alternatives achieve a certain protein content using vegetable sources such as soy (e.g. tofu, tempeh) or gluten/wheat (e.g. seitan). Today, modern techniques are used to make meat alternatives with more meat-like texture, flavor and appearance. Soy and gluten are favorable sources for such meat alternatives because they are widely available, affordable, relatively high in protein and well processable. In combination with the right technology, the formation of fibers is facilitated in soy or soy/gluten-based compositions, which is an aspect that is key for approaching the fibrous structure of animal meat. These properties as found when using soy or wheat or soy/gluten mixtures are generally not found in other plant-based proteins. Simultaneously however, there also is a strong driver to avoid soy and gluten for reasons of allergenicity and/or consumer trust. Manufacturers of meat alternatives turn to other proteins, for example like those derived from legumes, e.g. pea, fava bean, lupin, chickpea. However, use of these alternative protein sources is accompanied with new problems. The protein mixtures are often not as easily processible as the traditional soy or gluten or their combinations, and in many cases also lead to texturized food proteins that do not mimic the nutrition, texture, appearance, and/or the taste of animal-derived meat products. As a result, consumers typically consider such meat alternatives unappealing and unpalatable.

The majority of meat alternatives are made from plant-based materials produced by extrusion. Commonly, two types of extrusion are distinguished, high moisture (or wet) extrusion and dry extrusion.

The problem of poor texture, notably lack of fibrous texture, may be addressed by using high-moisture extrusion, leading to products with a highly fibrous nature, such as for example described in WO 2015/020873 for proteins that may be animal or plant-derived, or in WO 2019/143859 for compositions comprising two or more plant-based proteins that are not soy and do not contain gluten. Generally, in high-moisture extrusion, a water level of from 40 to 70% on the total extruder feed is used. In the process a blend of solids is fed into the extruder, water is added, and the material is kneaded into a homogeneous mass. A melt is formed at elevated temperature and pressure, which is fed into a cooling die where controlled cooling under flow leads to fibrous nature of the material. This material can be described as anisotropic, i.e. the properties and microstructure of the material are not the same in all three dimensions. Such anisotropic, fibrous material is clearly discernable while eating the product, and is generally linked to meat-like textures that are often also fibrous and anisotropic.

The problem of poor processability of certain alternative protein sources is a drawback that is most manifest in another technology used in the preparation of meat alternatives, namely dry extrusion. Dry extrusion is the preferred technology as it is cost effective, simple and robust, proven for decades and leads to material that can be used in meat alternatives with a relatively homogeneous texture, having a more isotropic character. Dry extrusion is used to make so-called texturized vegetable protein (TVP), which is material that forms the base of the largest categories of meat alternatives such as burgers, (“meat”) balls, breaded products such as nuggets alternatives or schnitzel alternatives, minced-meat-style products, (stir-fry) pieces, sausages and the like. Advantageously, dry extrusion leads to products with a low moisture content that are less susceptible to microbiological contamination due to the low water activity.

Unfortunately, dry extrusion of proteins from legumes or pulses like pea leads to difficulties in processing such as in-homogeneous extruder melts, as well as in-homogeneous expansion when the extrudates leave the extruder. And upon hydration of the resulting dry extruded products to make final products, the hydration is often too slow, the water holding capacity (or hydration capacity) can be too low, the hydrated material often is too soft, highly inhomogeneous, and does not have the typical ‘bite’ that is required for meat alternatives. There is a need for legume-derived protein compositions and dry extrusion processing of such compositions that do not have the problem of poor processability.

WO2021/009387 relates to a process for preparing a texturized vegetable protein comprising: mixing rapeseed protein, legume-derived protein, plant-based fiber, and from 5-30% (w/w) water in an extruder, heating the mixture obtained in step (a) to a temperature of from 100-180° C. and extruding the mixture obtained in step (b) through an extrusion die.

There remains a need in the art to improve the hydration capacity and/or to increase the hydration speed of the TVPs. Moreover, for several meat alternative applications a lighter appearance is desired.

### DETAILED DESCRIPTION OF THE INVENTION

In the context of the invention, the term “meat alternatives” also refers to meat analogue, meat substitute, mock meat, faux meat, imitation meat, vegetarian meat, fake meat, or vegan meat, and has texture, flavor, appearance or chemical characteristics of specific types of meat. Generally, meat alternatives refers to food made from vegetarian ingredients, and usually without animal derived products such as dairy or egg (leading to vegan products). Meat alternatives comprises also particles that resemble minced meat, such as ground beef, ground chicken, ground pork, ground turkey, ground veal and the like, Such particles can be brought together to form meat alternatives for meat products such as beef patties, hamburgers, meat-comprising sauces such as Bolognaise sauce, minced beef, minced chicken, minced pork, minced veal, nuggets, sausages and the like.

In a first aspect, the invention provides a process for preparing a texturized vegetable protein comprising:
(a) mixing rapeseed protein, legume-derived protein, from 0.1 to 10% (w/w) calcium carbonate and from 5-30% (w/w) water in an extruder,
(b) heating the mixture obtained in step (a) to a temperature of from 100-180° C. in an extruder,
(c) extruding the mixture obtained in step (b) through an extrusion die.

Surprisingly it has now been shown that adding calcium carbonate in the composition before extrusion improves the hydration rate and the water holding capacity, gives a lower density and a lighter appearance compared to the same composition without calcium carbonate. The level of calcium carbonate may range from 0.1-5%; 0.2-3% more preferably from 1.0-2.5% (w/w) of the present mixture.

Preferably the amount of water is 5-40% (w/w) water, 5-30% (w/w) water, or 10-30% (w/w) water, or 10-25% (w/w) water, or 15±10% (w/w) water. Preferably, the dry matter:water ratio in the mix is 6:1, 4:1 or 3:1 or 2.5:1 or between 6:1 to 3:1.

Upon feeding to the extruder, the rapeseed protein and/or legume-derived protein are preferably in dry form, i.e. comprising from 0-10% (w/w) water, preferably from 0-5% (w/w) water or 3±3% (w/w) water. In an embodiment, the rapeseed protein and/or the legume-derived protein and the calcium carbonate may be pre-hydrated, for example in a conditioner, prior to addition to the extruder. This has as advantage that process flow and/or pumpability may be improved. Plant-based fiber is added to further improve consistency/texture and/or nutritional value and/or as a filler. Preferably the amount of rapeseed protein may be from 2-75% (w/w), or from 5-50% (w/w), or from 10-30% (w/w), or 15-25% 20±15% (w/w) of the present mixture. Similarly, the amount of legume-derived protein may be from 10-95% (w/w), or from 20-85% (w/w), or from 40-80% (w/w), or from 45-75% (w/w), or from 50-80% (w/w), or from 50-65% (w/w) or 50±25% (w/w) of the present mixture. The ranges are subject to the proviso that the total sum does not exceed 100% (w/w).

In an embodiment, step (a) further comprises mixing a plant-based fiber, preferably mixing from 5 to 30% (w/W) plant-based fiber, of the weight of the mixture. Preferably, the amount of plant based fiber may be from 2-50% (w/w), or from 5-30% (w/w), or from 5-40% (w/w), or from 15-35% (w/w) or from 20-30% (w/w), or 25±15% (w/w) of the present mixture.

In a preferred embodiment step (a) comprises mixing from 10 to 30% (w/w) rapeseed protein and from 50 to 90% (w/w) legume-derived protein, of the weight of the mixture. In a further preferred embodiment, step (a) comprises mixing from 10 to 30% (w/w) rapeseed protein, from 50 to 90% (w/w) legume-derived protein, from 5 to 30% (w/w) plant based fiber and from 0.5 to 5% (w/w) calcium carbonate, of the weight of the mixture, wherein the total sum does not exceed 100% (w/w).

In an embodiment present step (a) does not comprise adding starch or pregelatinized starch. In other words, the present mixture preferably not comprises starch or pregelatinized starch.

The calcium carbonate is preferably in powder form. More preferably the calcium carbonate has a particle size comprising 35% of the particles have a size of <2 μm, preferably 45% of the particles have a size of <2 μm. Preferably the particle size is measured using light scattering on a particle size analyser. Preferably the amount of calcium carbonate is from 0.1 to 5% (w/w), preferably from 0.2 to 3% (w/w) more preferably from 1 to 2.5% (w/w) of the mixture. Preferably the calcium carbonate is ground natural calcium carbonate or precipitated calcium carbonate.

Rapeseed protein may be in the form of an isolate or a concentrate. Rapeseed protein isolate may be prepared from cold-pressed rapeseed oil seed meal as described in WO 2018/007492 resulting in a product with a protein content of from 50-98% (w/w), or from 70-95% (w/w) or of 90±5% (w/w). The rapeseed protein isolate may comprise of from 40-65% (w/w) cruciferins and of from 25-60% (w/w) napins as verified by Blue Native PAGE, for example as described in WO 2018/007492. Alternatively, the rapeseed protein isolate may comprise at least 80% (w/w), preferably at least 85% (w/W), preferably at least 90% (w/w), more preferably at least 95% (w/w) cruciferins as verified by Blue Native PAGE, for example as described in WO 2018/007492. Alternatively, the rapeseed protein isolate may comprise at least 80% (w/w), preferably at least 85% (w/w), preferably at least 90% (w/w), more preferably at least 95% (w/w) napins as verified by Blue Native PAGE, for example as described in WO 2018/007492. More preferably the rapeseed protein isolate comprises 10-40% (w/w) napins and 40-60% (w/w) cruciferins, preferably as verified by Blue Native PAGE, for example as described in WO 2018/007492. More preferably the rapeseed protein isolate comprises 25-35% (w/w) napins and 40-55% (w/w) cruciferins, preferably as verified by Blue Native PAGE, for example as described in WO 2018/007492.

In an embodiment the rapeseed protein isolate is low in anti-nutritional factors and contains less than 1.5% (w/w) phytate, preferably less than 0.5% (w/W) phytate, and is low in glucosinolates (<5 μmol/g) and low in phenolics (<10 mg/g). In an embodiment the rapeseed protein isolate has a high solubility, preferably in water, of at least 88% when measured over a pH range from 3 to 10.

In an embodiment the rapeseed protein isolate has a low mineral content, in particular low in sodium, and with that a low conductivity when dissolved in water. This is advantageous as minimizing salt content in food products, i.e. also in meat alternatives, is an important topic in addressing improvement of public health. A well-known legume-derived protein isolate like pea protein isolate has a sodium load that is relatively high. In contrast, rapeseed protein isolate may have a conductivity in a 2 wt. % aqueous solution of less than 9 mS/cm over a pH range of 2 to 12, for example of from 0.5-9 mS/cm, or from 1-7 mS/cm or 4±3 mS/cm.

Legume-derived proteins may be for instance from lupin, pea (yellow pea, green pea), bean (such as soy bean, fava (faba) bean, kidney bean, green bean, haricot bean, pinto bean, mung bean, adzuki bean), chickpea, lupin, lentil, and peanut, and the like. Fava bean and faba bean can be used interchangeably. Advantageously, the legume-derived protein is non-allergenic. In an embodiment the protein may be in the form of a flour, a concentrated flour (obtained for example by wind sifting), a concentrate (>60% protein) or an isolate (>80% protein), or a press cake or an extracted cake. Preferably, the present legume-derived protein is chosen from the group consisting of pea protein, fava bean protein, lupin protein, and soy protein.

Plant-based fibers may be added to the mixture to improve the texture, and/or firmness, and/or consistency, and/or the nutritional value and/or as a filler. Examples of plant-based fiber are pea fiber fava bean fiber, lupin fiber, oil seed fiber (such as sun flower seed fiber or cotton seed fiber), fruit fiber (such as apple fiber), cereal fiber (such as oat fiber, maize fiber, rice fiber), bamboo fiber, potato fiber, inulin, or combinations thereof. Fibers are commonly present in plant-based foods and cannot (completely) be broken down by the human digestive enzymes, are either water-soluble or water-insoluble fibers. They may consist of (mixtures of) cellulose, hemicellulose, pectins and other non-starch polysaccharides or plant cell-wall biopolymers. Fiber fractions are materials that also can comprise protein, starch, lignin and/or ash.

Other components that can be added in present step (a) or to the material are starch, either native or modified (chemically or physically), from any source such as tapioca, corn, potato, pea or other legume, wheat, rice or other cereal. Next to normal salt (sodium chloride), other salts can be added, like potassium salts, calcium salts. This can be soluble or insoluble salts and minerals. Insoluble salts can also act as inert fillers and ways to change the colour of the end product. Soluble salts such as sodium bicarbonate can also be added to increase the pH during processing or in the end product. Alternatively, acids can be used to reduce the pH in during the process or in the end product. Any type of acid can be used, such as malic acid, citric acid, lactic acid, phosphoric acid, tartaric acid. Such soluble salts and pH modulators can be added as a solid to the powder premix or dissolved in the water stream. The modulation of the pH during extrusion can be used advantageously as a means to modify the texture, flavour and appearance of the TVP, it can impact on density, and on mechanical properties (dry and after hydration) such as resilience or elasticity.

Preferably, the pH of the present mix of protein powder, fiber and possibly other ingredients and water is within the range of pH 6 to 10, preferably pH 6 to 7, preferably pH 7 to 9, preferably pH 7 to 8, preferably pH 6 to 8.

In an embodiment, the mix of protein powder, fiber and possibly other ingredients and water are brought into the extruder, either separately or (partially) combined. In the extruder, the screws knead the resulting mixture into a paste. The temperature at which this takes place may be from 40-200° C., 90-190° C., or from 110-180° C., or from 120-170° C. or from 130-140° C. or at 140±30° C.

In an embodiment, the process takes place at elevated pressure such as from 5-80 bar, or from 20-60 bar or at 40±30 bar. The skilled person understands that the choice of pressure is related to the scale of the extrusion process. Preferably, the process is carried out in a continuous mode.

During the above processing, a melt is formed in the extruder, which, in an embodiment, is released through holes at the end of the extruder, where immediate expansion occurs. This expansion may be caused by water flashing off, causing next to expansion also an immediate temperature reduction, converting the melt into a ‘glassier’ type of material. The number and size of the holes may vary, and can be any shape such as circular, elongated, ellipsoidal, or even more complex. In an embodiment, the stream leaving the extruder may be cut into pieces using methods known to the skilled person. Such methods may for example be a rotating knife directly at the exit of the extruder. This leads to particles of various sizes and shapes depending on the cutting mode. The latter refers to the rotation speed of the knife (which may be from 50-5000 rpm, or from 100-3000 rpm or at 1000±500 rpm), the distance between extruder head and rotating knife and the dimensions of the holes. This may lead to particles where 95% of the particles has a size of from 1-80 mm, or from 1.2-40 mm, or from 1.5-20 mm. The density for texturized vegetable proteins, preferably in the dry state (<8% water), obtained according to the process of the first aspect of the invention is from 100-500 g/L, or from 150-400 g/L, or from 120-350 g/L or 250±100 g/L.

In an embodiment, the resulting particles may be further dried to a moisture content below 10% or even below 5%. Optionally the particles are milled and or sieved before or after the drying.

As outlined above, prior art texturized vegetable proteins routinely are made from soy (flours or concentrates), wheat or gluten, and quite often combinations thereof. While the molecular understanding of the phenomena occurring during extrusion is not well understood, the speculation is that gluten is responsible for special functionalities, such as elasticity during the expansion stage directly after exiting the extruder, and crosslinking by rearrangement of sulfur-sulfur bridges in the melt stage. These favorable properties are lost when the use of soy and wheat/gluten is being avoided for potential allergenicity risks. Indeed, we found that extrudates based on legume-derived proteins such as pea alone resulted in irregular flow during processing, irregular and/or inhomogeneous particles, uneven expansion and sometimes clogging of the equipment. The same applies for combinations of legume-derived proteins and fibers, for example pea protein isolate plus pea fiber. With the process of the invention, it is found that the preparation of legume-based texturized vegetable proteins by means of dry extrusion can be improved by co-processing with rapeseed protein and calcium carbonate. The process of the invention also allows for the introduction of a higher pea fiber content than is commonly used, such as from 20-40% (w/w) on dry matter.

The use of certain legume-based plant proteins has a further disadvantage with respect to nutritional profile. This can be expressed in for instance a PDCAAS value (Protein digestibility-corrected amino acid score, a method of evaluating the quality of a protein based on both the amino acid requirements of humans and their ability to digest it) and a DIAAS value (Digestible Indispensable Amino Acid Score, more a protein quality score). In pea, for example, the PDCAAS is limiting because of a low level of tryptophan and sulfur-containing amino acids. And for its DIAAS, the sulfur-containing amino acids are the first limiting amino acids to meet requirements, and the DIAAS scores of such legumes are also relatively low, 0.78 for pea concentrate for example. The limiting sulfur amino acids in legumes can be complemented by addition of rapeseed protein, a protein found to have a favorable nutritional profile (DIAAS=1.1±0.1 for adults) and to be especially rich in sulfur amino acids. By mixing legume-based plant proteins with rapeseed protein, a more complete DIAAS score can be achieved/obtained.

In a second aspect the invention provides a composition comprising rapeseed protein, legume-derived protein and from 0.1 to 5% (w/w) calcium based on the weight of the composition, Preferably the composition of the second aspect is a texturized vegetable protein.

The present inventors found that a composition comprising calcium, as a result of an extrusion process using calcium carbonate, provides higher water holding capacity and improved hydration rate. This is advantageous in meat alternative industries where texturized vegetable proteins are hydrated and further processed into meat alternatives, on a large scale. An improved hydration rate provides efficiency of manufacturing the meat alternative products.

In an embodiment, the amount of calcium is from 0.2 to 5% (w/w), from 0.3 to 4% (w/w), from 0.5 to 3% (w/w) or from 0.6 to 2% (w/w) of the composition.

As in the first aspect, particles of various sizes and shapes may be obtained, depending on how cutting is executed following the extrusion. For example, particles that are useful for subsequent applications are those wherein 95% of the particles has a size of from 1-80 mm, or from 1.2-40 mm, or from 1.5-20 mm, or 6±4 mm.

In a preferred embodiment, the present composition has a hydration time which is at least 10% shorter than a comparable composition without (from 0.1 to 5% (w/w)) calcium, Preferably a hydration time of at least 15%, 20%, 25%, 30%, 35%, 40%, 45%, 50%, 55%, 60%, 65% shorter than a comparable composition without (from 0.1 to 5% (w/w)) calcium. Preferably an hydration time of 10% or 20% to 50% shorter than a comparable composition without (from 0.1 to 5% (w/w) calcium.

The present composition has preferably a density from 100-500 g/L, or from 150-400 g/L, or from 120-350 g/L or 250±100 g/L.

In an embodiment, the composition has a density of at least 10% lower than a comparable composition without from 0.1 to 5% (w/w) calcium. A comparable composition is a composition comprising additional amount of legume-derived protein instead of calcium. The density is preferably measured according to the following test: a 1000 mL cylinder was tarred, then filled with the present composition just above the 1000 mL mark, the cylinder was tapped 10 times on a table, then checked that it was exactly filled to 1000 mL—if not, additional composition was added, again followed by tapping on a table—and was weighed again. The measured weight was used as density in g/L. Preferably, the composition has a density of at least 15%, 20%, 25%, 30%, 35%, 40%, 45%, 50%, 55%, 60% or 65% lower than a comparable composition without from 0.1 to 5% (w/w) calcium.

In an embodiment, the present composition has a water holding capacity of at least 10% higher than a comparable composition without (from 0.1 to 5% (w/w)) calcium. A comparable composition is a composition comprising additional amount of legume-derived protein instead of calcium. Preferably the water holding capacity is calculated using the following formula:

[weight of hydrated composition]−[dry weight of composition]/[dry weight of composition]×100%.

Preferably, the composition has a water holding capacity of at least 15%, 20%, 25%, 30%, 35%, 40%, 45%, 50%, 55%, 60% or 65% higher than a comparable composition without (from 0.1 to 5% (w/w)) calcium.

Preferably the amount of rapeseed protein may be from 2-75% (w/w), or from 5-50% (w/w), or from 10-30% (w/w), or 15-25% 20±15% (w/w) of the present mixture. Similarly, the amount of legume-derived protein may be from 10-95% (w/w), or from 20-85% (w/w), or from 40-80% (w/w), or from 45-75% (w/w), or from 50-80% (w/w), or from 50-65% (w/w) or 50±25% (w/w) of the present composition. The ranges are subject to the proviso that the total sum does not exceed 100% (w/w).

In an embodiment, the present composition comprises from 10 to 30% (w/w) rapeseed protein and from 50 to 90% (w/w) legume-derived protein based on the weight of the composition.

The presence of rapeseed protein isolate in the composition advantageously reduces the amount of salt compared to prior art compositions. Legume-derived proteins often contain significant amounts of sodium, that may need to be labeled as sodium chloride. For example, the amount of sodium in pea protein isolate can be as high as 3% (w/w), and when expressed as sodium chloride, the amount in pea protein isolate is 7.5% (w/w). Consequently, a prior art texturized vegetable protein comprising 80% (w/w) pea protein isolate and up to 20% (w/w) fiber can contain 6% (w/w) sodium chloride on dry weight. Advantageously, the compositions of the present invention comprise less than 6% (w/w) sodium chloride, for example of from 0.1-5.5% (w/w) sodium chloride or from 1-5.5% (w/w) sodium chloride or from 2-5% (w/w) sodium chloride or from 2.5-4% (w/w) sodium chloride or 3±2% (w/w) sodium chloride on dry weight.

In an embodiment, said legume-derived protein is pea-derived protein or faba-bean derived protein, soybean-derived protein, chickpea-derived protein, lupin-derived protein, lentil-derived protein or peanut-derived protein. Legume-derived proteins may be for instance from lupin, pea (yellow pea, green pea), bean (such as soy bean, fava (faba) bean, kidney bean, green bean, haricot bean, pinto bean, mung bean, adzuki bean), chickpea, lupin, lentil, and peanut, and the like. Fava bean and faba bean can be used interchangeably. Advantageously, the legume-derived protein is non-allergenic. In an embodiment the protein may be in the form of a flour, a concentrated flour (obtained for example by wind sifting), a concentrate (>60% protein) or an isolate (>80% protein), or a press cake or an extracted cake. Preferably, the present legume-derived protein is chosen from the group consisting of pea protein, fava bean protein and lupin protein.

In an embodiment, the present composition further comprises a plant-based fiber, preferably from 5 to 30% (w/w) plant-based fiber based on the weight of the composition. Preferably, the amount of plant-based fiber may be from 2-50% (w/w), or from 5-30% (w/w), or from 5-40% (w/w), or from 15-35% (w/w) or from 20-30% (w/w), or 25±15% (w/w) of the present mixture.

In another embodiment said plant-based fiber is a legume-based fiber (such as pea fiber, fava bean fiber, lupin fiber, chickpea fiber), oil seed fiber (such as sun flower seed fiber or cotton seed fiber), fruit fiber (such as apple fiber), cereal fiber (such as oat fiber, maize fiber, rice fiber), bamboo fiber, potato fiber, inulin, or combinations thereof.

In a further embodiment, another source of non-animal-derived [protein-rich] material may be added to the composition such as a cereal-based, such as an oat-based, or a fungal-based, or a nut-based material.

In an embodiment, the composition does not comprise gluten or gliadin, i.e. the composition is so-called gluten-free. By gluten-free is meant that the composition comprises less than 20 ppm of gluten and more preferably less than 10 ppm of gluten. Gluten is usually measured by measuring the gliadin content, for example as described in WO 2017/102535. Therefore, according to the present invention there is provided a gluten-free composition comprising less than 10 ppm gliadin.

In another embodiment the composition does not comprise soy-derived protein. In still another embodiment the composition does not comprise gluten or gliadin and does not comprise soy-derived protein. Further, the present composition does preferably not comprise starch or pregelatinized starch.

In a preferred embodiment, the composition comprises a ratio by weight of cruciferin to napin in the range of from 1 cruciferin to 0.5 napin to 1 cruciferin to 1.5 napin. Alternatively, the present composition comprises a ratio of cruciferin to napin of at least 9 cruciferin to 1 napin, or comprising a ratio by weight of cruciferin to napin of 1 cruciferin to at least 9 napin.

Preferably, the composition comprises rapeseed protein comprising of from 40-65% (w/w) cruciferins and of from 35-60% (w/w) napins of the rapeseed protein, as verified by Blue Native PAGE, for example as described in WO 2018/007492. Alternatively, the composition comprises rapeseed protein comprising at least 80% (w/w), preferably at least 85% (w/w), preferably at least 90% (w/w), more preferably at least 95% (w/w) cruciferins of the rapeseed protein, as verified by Blue Native PAGE, for example as described in WO 2018/007492. Alternatively, the composition comprises rapeseed protein comprising at least 80% (w/w), preferably at least 85% (w/w), preferably at least 90% (w/w), more preferably at least 95% (w/w) napins of the rapeseed protein, as verified by Blue Native PAGE, for example as described in WO 2018/007492. More preferably the rapeseed protein comprises 10-40% (w/w) napins and 40-60% (w/w) cruciferins, preferably as verified by Blue Native PAGE, for example as described in WO 2018/007492. More preferably the rapeseed protein comprises 25-35% (w/w) napins and 40-55% (w/w) cruciferins, preferably as verified by Blue Native PAGE, for example as described in WO 2018/007492.

In a preferred embodiment, the present rapeseed protein (isolate) comprises 60 to 95 wt. % cruciferins and 5 to 40 wt. % napins, or 85 to 90 wt. % cruciferins and 5 to 15 wt. % napins or 60 to 80 wt. % cruciferins and 20 to 40 wt. % napins. Preferably, the present rapeseed protein comprises 65 to 75 wt. % cruciferins and 25 to 35 wt. % napins.

In a preferred embodiment, the present rapeseed protein (isolate) (not) comprises 0 to 20 wt. % cruciferins and 80 to 100 wt. % napins. Preferably, the present rapeseed protein (does not) comprises 0 to 10 wt. % cruciferins and 90 to 100 wt. % napins. Preferably, the present rapeseed protein (does not) comprises 1 to 5 wt. % cruciferins and 95 to 100 wt. % napins. Preferably, the present rapeseed protein (does not) comprises 1 to 15 wt, % cruciferins and 85 to 100 wt. % napins.

Preferably, the present rapeseed protein (isolate) comprises 40 to 65 wt. % 12S and 35 to 60 wt. % 2S. Preferably, the present rapeseed protein comprises 40 to 55 wt. % 12S and 45 to 60 wt. % 2S.

In a preferred embodiment, the present rapeseed protein (isolate) comprises 60 to 80 wt, % 12S and 20 to 40 wt. % 2S. Preferably, the present rapeseed protein comprises 65 to 75 wt. % 12S and 25 to 35 wt. % 2S. Preferably, the present rapeseed protein comprises 40 to 65 wt. % 12S and 20 to 40 wt. % 2S.

In a preferred embodiment, the present rapeseed protein (isolate) (does not) comprises 0 to 20 wt. % 12S and 80 to 100 wt. % 2S. Preferably, the present rapeseed protein (does not) comprises 0 to 10 wt. % 12S and 90 to 100 wt. % 2S. Preferably, the present rapeseed protein (does not) comprises 1 to 5 wt. % 12S and 95 to 100 wt. % 2S.

Preferably, the amounts of 12S and 2S is determined by sedimentation velocity analytical ultracentrifugation (SV-AUC) analysis. Preferably, the amounts of 12S and 2S is determined by sedimentation velocity analytical ultracentrifugation (SV-AUC) analysis using the following test:

samples of protein isolate are dissolved in a 3.0% (or 500 mM) NaCl saline solution and amounts determined using interference optics.

Preferably, the present composition has a PDCAAS nutritional value of more than 0.8, preferably more than 0.85, more than 0.86, more than 0.87, more than 0.88, more than 0.89, more than 0.90, more than 0.91, more than 0.92, more than 0.93, more than 0.94 or more than 0.95. Preferably the PDCAAS is within the range of 0.8 to 1.0.

In a third aspect, the invention provides the use of a composition of the second aspect in the preparation of a meat alternative.

Texturized vegetable proteins may be applied in meat alternatives by combining the texturized vegetable protein with water. In an embodiment, final products contain from 40-80% water, or from 50-70% water. In an embodiment, other components like flavors, herbs, spices, onion pieces, oil and or (solid) fats, thickeners and so forth, may be added. Components in the meat alternative may be bound together by the addition of a gelling agent, such as egg white, or other proteins such as potato protein or methyl cellulose. The mix may be kneaded into a homogeneous mass, formed in a certain shape such as, for example, the shape of a hamburger or a chicken nugget, and subsequently set by heating at a temperature of from 60-95° C. or at 80±10° C. Optionally, for hamburger style products first a deep-frying treatment may be applied to set the outer structure. Such products can be consumed directly or after heating. In an embodiment, a reddish moist plant-derived substance is brought in the meat alternative so as to mimic the appearance of products being raw or semi-raw. These products usually don't receive an extra heat treatment during production and are stored and distributed frozen or packed under protective environment before distribution. Before consumption the consumer usually cooks the product by for instance frying in the pan, deep frying or oven treatment. In another embodiment the formed product is coated to obtain for instance a crispy outer layer, such as a breaded coating, that can be heat set by for instance deep frying or oven treatment. In another embodiment the meat alternative can be filled with another material such as a cheese or imitation cheese.

In an embodiment, the meat alternatives for which the use of the composition of the invention may be intended are beef-like patty, a nugget, (“meat”) balls, minced-style products, (stir-fry) pieces or a sausage. In another embodiment the meat alternative is the ingredient of a meal sauce, such as minced-style in a ready to use vegetarian pasta sauce like a Bolognaise sauce.

In a fourth aspect the invention provides a meat alternative comprising the present composition, i.e. comprising a composition comprising rapeseed protein, legume-derived protein and from 0.1 to 5% (w/w) calcium based on the weight of the composition. Said legume-derived protein may be a pea-derived protein and said plant-based fiber may be pea fiber. Or a fava bean protein and fava bean fiber, or lupin protein and lupin fiber and so forth, or combinations of those such as fava bean protein and pea fiber or lupin protein and pea fiber. Or a soy-derived protein or combinations of soy-derived protein and wheat-based material such as wheat gluten. Preferably the meat alternative does not comprise gluten or gliadin. In another embodiment the meat alternative does not comprise soy-derived protein. In still another embodiment the meat alternative does not comprise gluten or gliadin and does not comprise soy-derived protein. In still another embodiment the meat alternative does not contain animal-derived material.

In an embodiment, the meat alternative of the fourth aspect has an amount of sodium chloride that is lower than that of prior art meat alternatives based on pea protein isolate or other pulse protein isolates. Prior art meat alternatives are hydrated texturized vegetable proteins wherein the amount of water is, about twice the amount or higher of texturized vegetable proteins and these meat alternatives contain 2% (w/w) or more sodium chloride. Advantageously, the meat alternatives of the present invention comprise less than 2% (w/w) sodium chloride, for example of from 0.5-1.8% (w/w) sodium chloride or from 0.8-1.5% (w/w) sodium chloride or from 1-1.3% (w/w) sodium chloride or 1±0.5% (w/w) sodium chloride.

Preferably, the meat alternative comprises rapeseed protein comprising of from 40-65% (w/w) cruciferins and of from 35-60% (w/w) napins of the rapeseed protein, as verified by Blue Native PAGE, for example as described in WO 2018/007492. Alternatively, the meat alternative comprises rapeseed protein comprising at least 80% (w/w), preferably at least 85% (w/w), preferably at least 90% (w/w), more preferably at least 95% (w/w) cruciferins of the rapeseed protein, as verified by Blue Native PAGE, for example as described in WO 2018/007492. Alternatively, the meat alternative comprises rapeseed protein comprising at least 80% (w/w), preferably at least 85% (w/w), preferably at least 90% (w/w), more preferably at least 95% (w/w) napins of the rapeseed protein, as verified by Blue Native PAGE, for example as described in WO 2018/007492.

According to another aspect, the present invention relates to use of calcium carbonate for improving the hydration rate, water holding capacity and/or density of a texturized vegetable protein comprising rapeseed protein. Preferably wherein the texturized vegetable protein is a composition as defined herein.

The invention is further illustrated in the examples below, wherein reference is made to the figures:

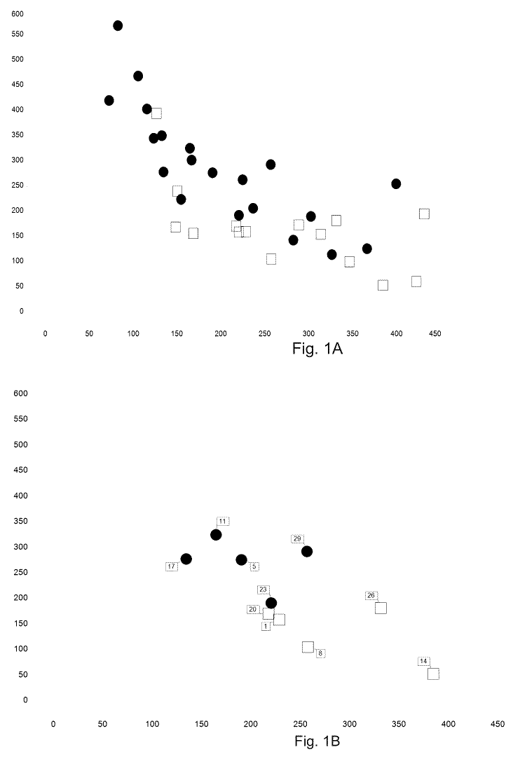

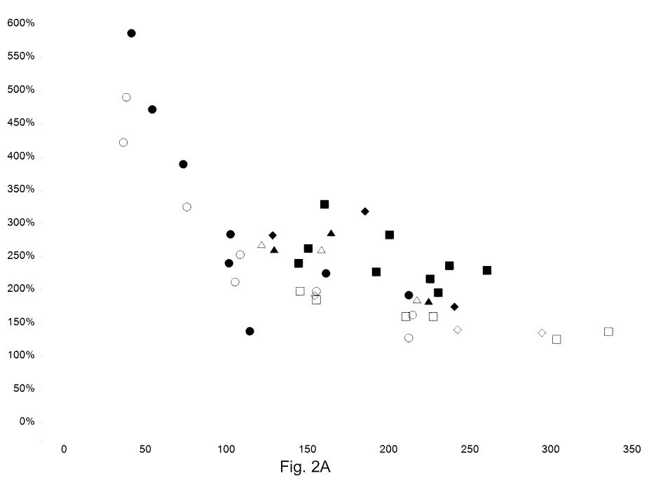

FIGS. 1A and 1B present values from table I of example 1. X axis: Density before drying (g/L), Y axis: maximum water absorption (%). Open squares represent products without CaCO3, closed circles products with CaCO3. FIG. 1A shows all values from Table I.

FIG. 1B shows a selection of product to highlight comparisons, values based on products produced at a dry matter/weight of 3.3. These pairs exist (without/with CaCO3): 1-5; 8-11; 14-17; 20-23; 26-29.

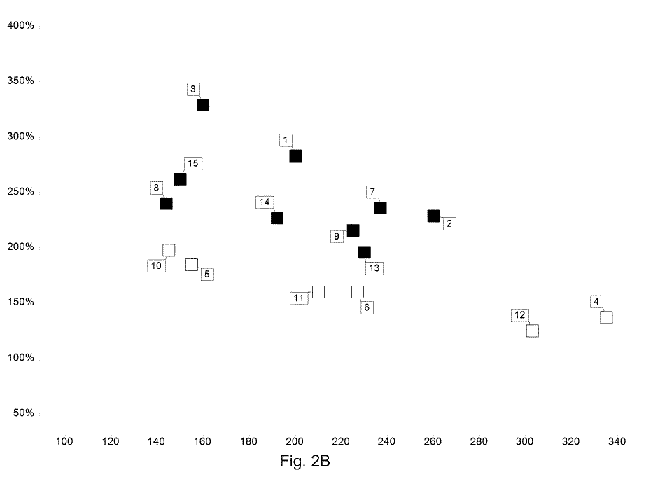

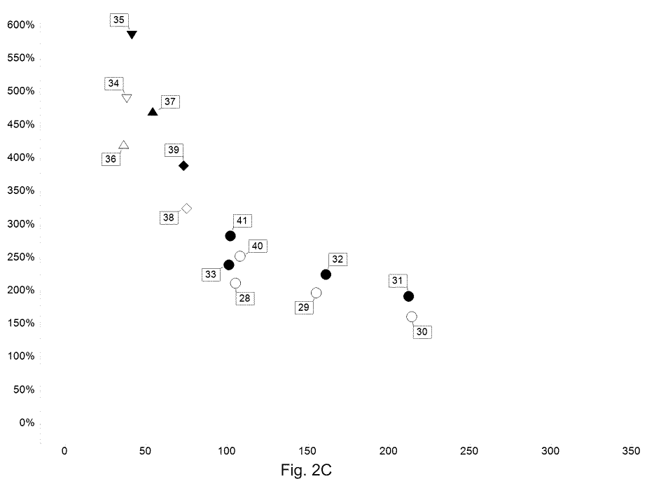

FIGS. 2A, 2B, and 2C present values from Table II of example 2. X axis: Density before drying (g/L), Y axis: maximum water absorption (%). Open markers: products without CaCO3, closed markers products with CaCO3. Marker shape represents faba bean source: Squares=A, Circles=B; diamonds=C; Triangles=D. FIG. 2A shows all values from Table II, showing that all closed markers representing products made with CaCO3 lie higher than the open markers (no CaCO3), indicating that with calcium carbonate the maximum water absorption capacity was higher. FIG. 2B shows only the values for Faba A at screw speed of 600 rpm to highlight the comparisons, note that both axes don't start at 0. These pairs that directly compare exist (without/with CaCO3 at (nearly) same processing conditions): 4-1; 6-3; 12-7; 10-15; 11-14:12-13. FIG. 2C shows the results for Fava source B and varying screw speed, as indicated by the markers (circles: 600 rpm, diamonds: 800 rpm, triangles up: 1000 rpm, triangles down: 1200 rpm) indicating that the effect on improving the maximum water holding capacity is independent of the screw speed. Here these pairs exist (without/with CaCO3): 30-31; 29-32; 28-40 and 33-41 (all DM/W at 600 rpm); 38-39 (800 rpm); 36-37 (1000 rpm); 34-35 (1200 rpm).

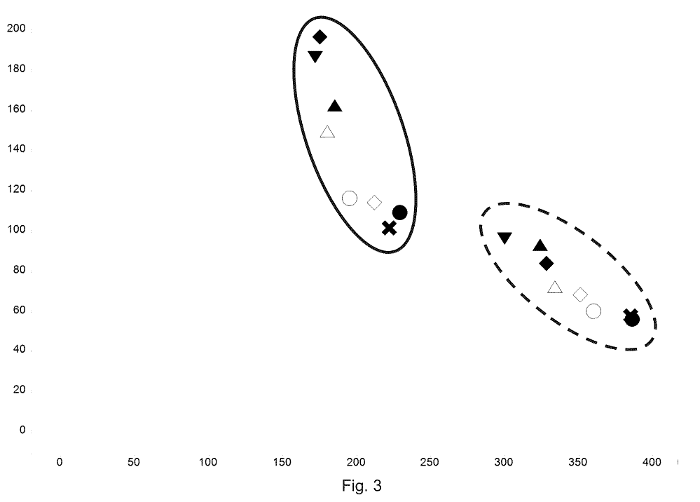

FIG. 3 presents values from Table III of example 3. X axis: Density after drying (g/L), Y axis: maximum water absorption in %. Open markers: products with CaCO3 type B, closed markers: products with CaCO3 type C. Marker shape represents level of CaCO3: cross=no CaCO3; circles=0.5%; diamonds=1%; triangles up=2%; triangles down=3%. The samples within the closed oval were processed at a DM/W of 4.0, the samples within the dotted oval were processed at a DM/W of 3.3.

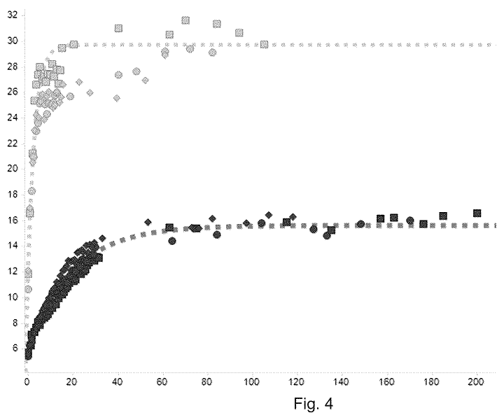

FIG. 4 shows the time-domain NMR relaxation data showing amplitude of the absorbed-water signal (Population size in arbitrary units) versus time (min), light grey symbols represent sample 11 from example 1, closed symbols represent sample 8 from example 1, symbol shape represent the triplicate measurements.

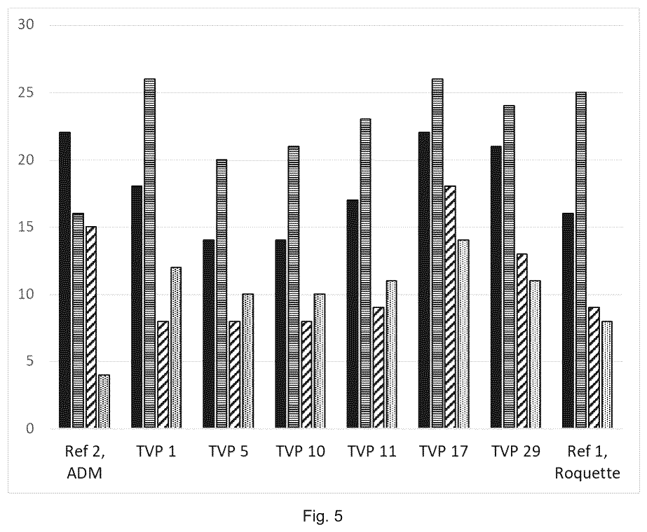

FIG. 5 presents an evaluation from a taste panel for various hamburger style products made with texturized vegetable protein. Solid bar: Beany; horizontally striped bar: Pea like; diagonally striped bar: Astringency bar; dotted: rapeseed like.

### EXAMPLES

### Materials and Methods

Rapeseed protein isolate (RPI) was prepared from cold-pressed rapeseed oil seed meal as described in WO 2018/007492; the protein content was 90% (w/w). The resultant RPI comprised in the range of from 40 to 65% (w/w) cruciferins and 35 to 60% (w/w) napins, contained less than 0.26% (w/w) phytate and had a solubility of at least 88% when measured over a pH range from 3 to 10 at a temperature of 23±2° C. pH measurements were carried out using a Radiometer model PHM220 pH meter equipped with a PHC3085-8 Calomel Combined pH electrode (D=5 MM).

Pea protein isolate (PPI) was DMPP80plus (Jianyuan, China) or Pisane C9 (Cosucra, France). Pea fiber was Swelite (Cosucra, France)

Four different fava bean protein sources were used:
Fava A: ABM-HT 60-HT, Roland Beans, Germany
Fava B: Faba Bean Protein 60—Deflavored: FFBP-60-D, AGT Foods and Ingredients, Canada
Fava C: HP60-HTEX, Roland Beans, Germany
Fava D: RB HP60 nativ, Roland Beans, Germany
Calcium Carbonate type A: unknown source, type B: Calcipur 95-KP, Omya, Switzerland, with 35%<2 μm; type C: Calcipur 115-KP, Omya, Switzerland, with 45%<2 μm.

Commercial reference products used were soy-based TVP Arcon TU180 (ADM) and pea-based TVP Nutralys TP70G (Roquette, France).

### Methods

### Density

A 1000 mL cylinder was tarred, then filled with TVP material just above the 1000 mL mark, the cylinder was tapped 10 times on a table, then checked that it was exactly filled to 1000 mL—if not, additional material was added, again followed by tapping on a table—and was weighed again. The measured weight was used as density in g/L. In most cases the material was measured directly from the line before drying and is therefore called density before drying. For some tests also the density was measured after further drying, increasing the density.

### Maximum Water Holding Capacity

The maximum water holding capacity (hydration capacity) was determined by hydrating material: 100 g TVP was collected into a (pre-weighed) sieve and allowed to hydrate for >10 minutes in excess water at room temperature. The sieve was taken out of the water, remaining water was drained by tapping the sieve five times on a table, cleaning the bottom of the sieve with a tissue and the hydrated material was weighed. From this, the maximum water holding capacity in gram of water per gram of TVP was calculated, using the following formula:

[weight of hydrated TVP]−[dry weight of TVP]/[dry weight of TVP]×100%

Strictly, the water content of the dry TVP should be taken into account, but since the products were all dried to <5%, this was neglected.

### Particle-Size Distribution

Particle size distribution of the extrudates was determined by using three sieves stacked on top of each other, the top one with square holes of 5.0 mm, the middle one with square holes of 2.8 mm and the bottom one with square holes of 1.0 mm, leading to four fractions >5.0 mm; 5.0-2.8 mm, 2.8-1.0 mm; <1.0 mm. 100±0.2 gram TVP was brought on the largest sieve. The material was shaken horizontally for 10 seconds, and the weight of the fractions on the various sieves was determined. The <1.0 mm fraction was too small to determine correctly. The particle size distribution is expressed as a weight percentage,

### Hydration Time

The hydration rate was determined by adding an excess of water to 30-50 gram dry extrudates and per minute is analyzed whether hydration was equilibrated. For example by squeezing hydrated particles between the fingers to sense whether the hydration was equilibrated or by Time-Domain NMR (TD NMR).

### Example 1

Texturized Vegetable Protein with Pea

Dry extruded material was produced on a Bühler BCTL twin-screw extruder. A mix of solid powders was made, with varying compositions as indicated in percentages in Table I. As pea protein isolate DMPP80plus was used, except for sample 31-33 where Pisane F9 was used (indicated by the asterisk in the table). CaCO3 type A was used. The powder mix was fed using a gravimetric solid feeder into the first barrel with a throughput of 40 kg/hr. Water was fed with a gravimetric peristaltic pump at varying levels: 10, 12 or 14 kg/hr. This is indicated in Table I as a dry matter over water ratio (DM/W) respectively as 4.0, 3.3, 2.9. The screw speed was set at 600 rpm, in all cases was the exit temperature around 145+/−15° C. At the end of the barrel a die plate with two spherical holes of 3 mm diameter was placed. Material exiting the barrel was immediately cut into pieces by a cutter, a rotating knife. This cutter rotated with 1000 rpm except for variants 8, 9 and 10 (500 rpm). The material was collected on trays and further dried in an oven to a water level below 5%.

TVPs made in this way were characterized by their density (before drying), water holding capacity (after drying), and particle size distribution (after drying). The results are given in Table 1 and illustrated in FIG. 1. In table 1 PSD means particle size distribution.

The hydration time was determined for a limited set of products, all processed at a dry matter/weight of 3.3:

Sample 1 (no CaCO3): 11 min.; sample 5:6 min.; sample 11:5.5 min.; Sample 17:6.5 min.; Sample 29:5 min.; Sample 32:4 min (all with CaCO3); and the soy-based reference (Arcon TU180) 23 min: It is clear from this series that the legume-based TVP product without CaCO3 (#1) and the soy-based reference needed far longer to come to equilibrated hydrated state, whereas that product had a similar density as #5, 29 and 32.

Conclusion: from the results in Table I and FIGS. 1A and 1B it is clear that with the addition of calcium carbonate, the density reduced and that the maximum water holding capacity increased.

TABLE 1

| | | | | | | | Maximum | | | | | |
|---|---|---|---|---|---|---|---|---|---|---|---|---|
| | | | | | | density | Water | | | | | |
| | | | | | | before | holding | | PSD | PSD | | |
| sample | pea | pea | Canola | | DM/W | drying | capacity | PSD >5.0 | 5.0-2.8 | 2.8-1.0 | PSD <1.0 | PSD |
| # | protein | fiber | protein | CaCO₃ | [—] | (g/L) | [%] | mm | mm | mm | mm | Total |
| 1 | 60 | 20 | 20 | 0 | 3.3 | 228 | 159 | 94.8 | 4.5 | 0.1 | 0.5 | 99.9 |
| 2 | 60 | 20 | 20 | 0 | 4.0 | 168 | 156 | 91.5 | 6.5 | 1.0 | 0.5 | 99.5 |
| 3 | 60 | 20 | 20 | 0 | 2.9 | 313 | 155 | 75.2 | 16.8 | 6.3 | 2.0 | 100.3 |
| 4 | 58 | 20 | 20 | 2 | 2.9 | 224 | 263 | 76.3 | 17.0 | 5.4 | 1.0 | 99.7 |
| 5 | 58 | 20 | 20 | 2 | 3.3 | 190 | 276 | 92.5 | 6.6 | −0.2 | 0.6 | 99.5 |
| 6 | 58 | 20 | 20 | 2 | 4.0 | 166 | 302 | 87.1 | 9.3 | 3.3 | 0.7 | 100.4 |
| 7 | 70 | 10 | 20 | 0 | 4.0 | 220 | 159 | 86.4 | 10.5 | 3.0 | 0.7 | 100.6 |
| 8 | 70 | 10 | 20 | 0 | 3.3 | 257 | 105 | 89.3 | 8.8 | 1.6 | 0.9 | 100.6 |
| 9 | 70 | 10 | 20 | 0 | 2.9 | 346 | 100 | 65.3 | 28.4 | 5.8 | 0.6 | 100.1 |
| 10 | 68 | 10 | 20 | 2 | 2.9 | 326 | 114 | 78.7 | 17.4 | 3.6 | 0.7 | 100.4 |
| 11 | 68 | 10 | 20 | 2 | 3.3 | 164 | 325 | 95.7 | 3.7 | 0.1 | 0.5 | 100.0 |
| 12 | 68 | 10 | 20 | 2 | 4.0 | 132 | 350 | 97.3 | 2.4 | 0.2 | 0.4 | 100.3 |
| 13 | 80 | 0 | 20 | 0 | 4.0 | 148 | 169 | 94.1 | 4.6 | 1.0 | 0.4 | 100.1 |
| 14 | 80 | 0 | 20 | 0 | 3.3 | 384 | 53 | 73.3 | 23.5 | 2.9 | 0.4 | 100.1 |
| 15 | 80 | 0 | 20 | 0 | 2.9 | 422 | 60 | 59.1 | 31.2 | 8.3 | 0.8 | 99.4 |
| 16 | 78 | 0 | 20 | 2 | 2.9 | 282 | 143 | 76.0 | 21.3 | 1.3 | 0.5 | 99.1 |
| 17 | 78 | 0 | 20 | 2 | 3.3 | 134 | 278 | 97.3 | 2.3 | −0.7 | 0.4 | 99.3 |
| 18 | 78 | 0 | 20 | 2 | 4.0 | 82 | 569 | 99.6 | 0.3 | −0.3 | 0.3 | 99.9 |
| 19 | 100 | 0 | 0 | 0 | 4.0 | 150 | 240 | 93.9 | 4.9 | 0.0 | 0.9 | 99.7 |
| 20 | 100 | 0 | 0 | 0 | 3.3 | 217 | 171 | 85.9 | 11.3 | 2.0 | 0.6 | 99.8 |
| 21 | 100 | 0 | 0 | 0 | 2.9 | 288 | 173 | 79.0 | 16.4 | 3.6 | 1.3 | 100.3 |
| 22 | 98 | 0 | 0 | 2 | 2.9 | 302 | 190 | 78.6 | 16.2 | 4.1 | 0.8 | 99.7 |
| 23 | 98 | 0 | 0 | 2 | 3.3 | 220 | 192 | 87.2 | 11.4 | −0.3 | 0.5 | 98.8 |
| 24 | 98 | 0 | 0 | 2 | 4.0 | 123 | 345 | 94.3 | 4.1 | 0.2 | 0.6 | 99.2 |
| 25 | 80 | 20 | 0 | 0 | 4.0 | 126 | 394 | 96.8 | 2.7 | 0.2 | 0.5 | 100.2 |
| 26 | 80 | 20 | 0 | 0 | 3.3 | 331 | 182 | 69.8 | 17.3 | 10.8 | 2.5 | 100.4 |
| 27 | 80 | 20 | 0 | 0 | 2.9 | 431 | 195 | 79.7 | 15.3 | 3.4 | 1.8 | 100.2 |
| 28 | 78 | 20 | 0 | 2 | 2.9 | 399 | 254 | 71.5 | 19.3 | 8.0 | 1.9 | 100.7 |
| 29 | 78 | 20 | 0 | 2 | 3.3 | 256 | 293 | 74.8 | 19.1 | 5.3 | 1.0 | 100.2 |
| 30 | 78 | 20 | 0 | 2 | 4.0 | 105 | 468 | 97.2 | 2.0 | 0.2 | 0.6 | 100.0 |
| 31 | 68* | 10 | 20 | 2 | 2.9 | 236 | 206 | 62.6 | 23.4 | 12.0 | 1.6 | 99.0 |
| 32 | 68* | 10 | 20 | 2 | 3.3 | 154 | 224 | 79.6 | 17.1 | 1.8 | 0.5 | 100.0 |
| 33 | 68* | 10 | 20 | 2 | 4.0 | 72 | 420 | 97.6 | 2.0 | 0.0 | 0.3 | 99.8 |

### Example 2

Texturized Vegetable Protein with Fava

In a similar set up as described in example 1, a set of products was made based on compositions with fava bean flour (four variants) and rapeseed protein isolate. CaCO3 type A was used. The results are given in Table II below. Moreover, several processing variations were done such as the dry matter versus water ratio, as well as the screw speed, as indicated in the table. The cutter was always run at 3000 rpm (#1-3) and 1500 rpm (the rest) and temperature at the end of the extruder of 150+/−20° C.

During production, the water holding capacity of most of the products was determined, and from that it was clear that products without CaCO3 were not yet fully hydrated in 10 minutes: hard and crunchy pieces were still present, that only disappear upon longer equilibration, whereas their equivalents with CaCO3 were all fully hydrated within 10 minutes. The hydration time was only determined by above mentioned method for three samples, all containing CaCO3: sample 3:1.5 min; sample 20:6 min.; sample 38:6 min., which is all within the targeted range of <10 minutes.

Conclusion: from the results in Table II and the graphical representation in FIGS. 2A, 2B and 2C it is clear that with the addition of calcium carbonate, the density reduced and the maximum water holding capacity (hydration capacity) increased. Also, the hydration rate was increased by the addition of CaCO3.

TABLE 2

| | | | | | | | | | | Maximum |
|---|---|---|---|---|---|---|---|---|---|---|
| | | | | | | | | | density | water |
| patent | | Fava | Canola | | solid | liquid | | screw | before | holding |
| example | Fava | bean | protein | CaCO3 | feed | feed | DM/W | speed | drying | capacity |
| 2.# | type | [%] | [%] | [%] | kg/hr | kg/hr | [—] | [rpm] | (g/L) | [%] |
| 1 | A | 78 | 20 | 2 | 35 | 12 | 2.9 | 600 | 200 | 283% |
| 2 | A | 78 | 20 | 2 | 35 | 14 | 2.5 | 600 | 260 | 229% |
| 3 | A | 78 | 20 | 2 | 35 | 10 | 3.5 | 600 | 160 | 329% |
| 4 | A | 80 | 20 | 0 | 35 | 12 | 2.9 | 600 | 335 | 137% |
| 5 | A | 80 | 20 | 0 | 47 | 10 | 4.7 | 600 | 155 | 185% |
| 6 | A | 80 | 20 | 0 | 47 | 12 | 3.9 | 600 | 227 | 160% |
| 7 | A | 98 | 0 | 2 | 47 | 14 | 3.4 | 600 | 237 | 236% |
| 8 | A | 98 | 0 | 2 | 47 | 8 | 5.9 | 600 | 144 | 240% |
| 9 | A | 98 | 0 | 2 | 47 | 9.5 | 4.9 | 600 | 225 | 216% |
| 10 | A | 70 | 30 | 0 | 47 | 10 | 4.7 | 600 | 145 | 198% |
| 11 | A | 70 | 30 | 0 | 47 | 12 | 3.9 | 600 | 210 | 160% |
| 12 | A | 70 | 30 | 0 | 47 | 14 | 3.4 | 600 | 303 | 125% |
| 13 | A | 68 | 30 | 2 | 47 | 14 | 3.4 | 600 | 230 | 196% |
| 14 | A | 68 | 30 | 2 | 47 | 12 | 3.9 | 600 | 192 | 227% |
| 15 | A | 68 | 30 | 2 | 47 | 10 | 4.7 | 600 | 150 | 262% |
| 16 | C | 80 | 20 | 0 | 45 | 14 | 3.2 | 600 | 294 | 135% |
| 17 | C | 80 | 20 | 0 | 45 | 12 | 3.8 | 600 | 242 | 140% |
| 18 | C | 80 | 20 | 0 | 45 | 10 | 4.5 | 600 | 154 | 191% |
| 19 | C | 78 | 20 | 2 | 45 | 10 | 4.5 | 600 | 128 | 282% |
| 20 | C | 78 | 20 | 2 | 45 | 12 | 3.8 | 600 | 185 | 318% |
| 21 | C | 78 | 20 | 2 | 45 | 14 | 3.2 | 600 | 240 | 174% |
| 22 | D | 80 | 20 | 0 | 52 | 10 | 5.2 | 600 | 121 | 268% |
| 23 | D | 80 | 20 | 0 | 52 | 12 | 4.3 | 600 | 158 | 261% |
| 24 | D | 80 | 20 | 0 | 52 | 14 | 3.7 | 600 | 217 | 185% |
| 25 | D | 78 | 20 | 2 | 52 | 14 | 3.7 | 600 | 224 | 183% |
| 26 | D | 78 | 20 | 2 | 52 | 12 | 4.3 | 600 | 164 | 286% |
| 27 | D | 78 | 20 | 2 | 52 | 10 | 5.2 | 600 | 129 | 261% |
| 28 | B | 80 | 20 | 0 | 47 | 10 | 4.7 | 600 | 105 | 212% |
| 29 | B | 80 | 20 | 0 | 47 | 12 | 3.9 | 600 | 155 | 198% |
| 30 | B | 80 | 20 | 0 | 47 | 14 | 3.4 | 600 | 214 | 162% |
| 31 | B | 78 | 20 | 2 | 47 | 14 | 3.4 | 600 | 212 | 192% |
| 32 | B | 78 | 20 | 2 | 47 | 12 | 3.9 | 600 | 161 | 225% |
| 33 | B | 78 | 20 | 2 | 47 | 10 | 4.7 | 600 | 101 | 240% |
| 34 | B | 70 | 30 | 0 | 47 | 10 | 4.7 | 1200 | 38 | 490% |
| 35 | B | 68 | 30 | 2 | 47 | 10 | 4.7 | 1200 | 41 | 586% |
| 36 | B | 70 | 30 | 0 | 47 | 10 | 4.7 | 1000 | 36 | 422% |
| 37 | B | 68 | 30 | 2 | 47 | 10 | 4.7 | 1000 | 54 | 471% |
| 38 | B | 70 | 30 | 0 | 47 | 10 | 4.7 | 800 | 75 | 325% |
| 39 | B | 68 | 30 | 2 | 47 | 10 | 4.7 | 800 | 73 | 389% |
| 40 | B | 70 | 30 | 0 | 47 | 10 | 4.7 | 600 | 108 | 253% |
| 41 | B | 68 | 30 | 2 | 47 | 10 | 4.7 | 600 | 102 | 283% |

### Example 3

### Extrusion Pea Protein Isolate and Rapeseed Protein Isolate at Different CaCO3 Types and Concentration

In a similar set up as described in example 1, a set of products was made based on pea protein isolate DMPP80plus, rapeseed protein isolate and pea fiber, with and without CaCO3 types B and C in a varying amount. The compositions and several basic characteristics are given in Table 3 below. The processes were run at a screw speed of 600 rpm and a cutter speed of 500 rpm, two holes with a diameter of 3 mm, and at various dry matter versus water ratios.

The results show that a higher CaCO3 concentration led to a lower density and a higher water absorption level. Also, it shows that CaCO3 type C had a larger effect than type B. About 2% of CaCO3 was sufficient to obtain a sufficient effect. The overall particle size distribution was fairly constant over this variation.

TABLE 3

| | | | | | | | | | Maximum |
|---|---|---|---|---|---|---|---|---|---|
| | | | | | | | density | density | water |
| | | | | | | | before | (g/L) | holding |
| | pea | pea | Canola | CaCO₃ | CaCO₃ | DM/W | drying | after | capacity |
| # | protein | fiber | protein | type B | type C | [—] | (g/L) | drying | [%] |
| 1 | 69.5 | 10.0 | 20.0 | 0.5 | 0.0 | 4.0 | 225 | 195 | 116 |
| 2 | 69.5 | 10.0 | 20.0 | 0.5 | 0.0 | 3.3 | 313 | 360 | 60 |
| 3 | 69.0 | 10.0 | 20.0 | 1.0 | 0.0 | 3.3 | 223 | 351 | 68 |
| 4 | 69.0 | 10.0 | 20.0 | 1.0 | 0.0 | 4.0 | 180 | 212 | 114 |
| 5 | 69.0 | 10.0 | 20.0 | 1.0 | 0.0 | 2.9 | 370 | 397 | 62 |
| 6 | 68.0 | 10.0 | 20.0 | 2.0 | 0.0 | 2.9 | 385 | 401 | 75 |
| 7 | 68.0 | 10.0 | 20.0 | 2.0 | 0.0 | 3.3 | 324 | 334 | 72 |
| 8 | 68.0 | 10.0 | 20.0 | 2.0 | 0.0 | 4.0 | 180 | 180 | 149 |
| 9 | 70.0 | 10.0 | 20.0 | 0.0 | 0.0 | 4.0 | 205 | 222 | 101 |
| 10 | 70.0 | 10.0 | 20.0 | 0.0 | 0.0 | 3.3 | 340 | 385 | 57 |
| 11 | 70.0 | 10.0 | 20.0 | 0.0 | 0.0 | 2.9 | 385 | 395 | 62 |
| 12 | 69.5 | 10.0 | 20.0 | 0.0 | 0.5 | 3.3 | 352 | 386 | 56 |
| 13 | 69.5 | 10.0 | 20.0 | 0.0 | 0.5 | 4.0 | 200 | 229 | 109 |
| 14 | 69.0 | 10.0 | 20.0 | 0.0 | 1.0 | 4.0 | 160 | 175 | 196 |
| 15 | 69.0 | 10.0 | 20.0 | 0.0 | 1.0 | 3.3 | 295 | 328 | 84 |
| 16 | 68.0 | 10.0 | 20.0 | 0.0 | 2.0 | 3.3 | 286 | 324 | 93 |
| 17 | 68.0 | 10.0 | 20.0 | 0.0 | 2.0 | 4.0 | 160 | 185 | 162 |
| 18 | 67.0 | 10.0 | 20.0 | 0.0 | 3.0 | 4.0 | 153 | 172 | 186 |
| 19 | 67.0 | 10.0 | 20.0 | 0.0 | 3.0 | 3.3 | 255 | 300 | 96 |
| 20 | 88.0 | 10.0 | 0.0 | 0.0 | 2.0 | 3.3 | 250 | 315 | 143 |
| 21 | 88.0 | 10.0 | 0.0 | 0.0 | 2.0 | 4.0 | 160 | 180 | 227 |

### Example 4

### Hydration Time

The hydration time was determined using Time-Domain NMR (TD NMR). The technique measures the relaxation rate of protons in a magnetic field. This relaxation rate depends on the environment of the protons. In this way a fraction of protons can be attributed to the amount of absorbed water in a sample [B. L. Dekkers et al, Food Hydrocolloids 60 (2016) 525-532]. Upon hydration of the TVP this amount of absorbed water will increase until it has reached an equilibrium.

Two products from example 1 were studied: sample 11 with CaCO3 [68/10/20/2Ca] and sample 8: no CaCO3 [70/10/20/0Ca]. A weighed amount of dry TVP was added into an NMR tube, on t=0 a defined amount of water was added to the tube of 10 mm diameter and immediately brought into the NMR instrument [Bruker, Minispec MQ20, Bruker, Germany], and each minute the relaxation decay was measured at room temperature. Each sample was measured in triplicate. The relaxation data was processed as described by a method described by B. L. Dekkers et al. Food Hydrocolloids 60 (2016) 525-532. From this, the amplitude for absorbed water signal was followed in time. From this it was determined that the half-time of hydration for sample 11 with CaCO3 was about 4 minutes and that of sample 8, without CaCO3 was around 20 minutes. This is shown in FIG. 4.

### Example 5

### Hamburger-Style Demo Product

Model hamburgers were made with the different extruded texturized vegetable protein products, described in example #1. Commercial products of Roquette TP70G and ADM Arcon TU180 soy were included as controls. The following set of samples was selected for evaluation in a final product application.

Table 4 shows the composition of selected TVP's for evaluation in burger application:

TABLE 4

| # | | | | | |
|---|---|---|---|---|---|
| TVP [see | Pea | | Canola | | |
| example | protein | | protein | Calcium | |
| 1] | isolate | Pea fibers | isolate | carbonate | Remarks |
| 1 | 60 | 20 | 20 | 0 | With versus |
| | | | | | without |
| 5 | 58 | 20 | 20 | 2 | Calcium |
| | | | | | carbonate |
| 10 | 68 | 10 | 20 | 2 | DM/W of 2.9 |
| 11 | 68 | 10 | 20 | 2 | versus 3.3 |
| 17 | 78 | 0 | 20 | 2 | No fiber |
| 29 | 78 | 20 | 0 | 2 | No rapeseed |
| | | | | | protein |
| | | | | | isolate |

The model burgers were not flavored. The ingredients as shown in table were used for preparation of 8 different hamburgers. First caramelized sugar and beetroot powder were dry mixed separately and then added to the water used for hydration of the TVPs. Hydration was performed for 45 minutes at room temperature, the TVPs were gently mixed using a spoon every 10 minutes. The binder was prepared separately by combining the gellan gum and methylcellulose in sunflower oil. All were mixed in a blender (Cuisine system 5200XL, Magimix) for 45 seconds at fixed speed. Then the ice-cold water was slowly added while mixing under high shear in the blender. The paste-like emulsion was mixed with the hydrated texturized vegetable protein until homogeneous appearance of the dough in a kitchen mixer (Bear Varimixer, Teddy). The soy protein isolate and salt were mixed through the dough for 30 seconds at low speed, followed by the frozen coconut fat chunks, and gently mixed for 10-15 seconds, Hamburgers of 130 grams each were shaped with use of a mould. The hamburgers were frozen within 90 minutes with use of a blast freezer and then transferred to a normal freezer.

For testing, the burgers were thawed until a core temperature of around 7° C. and prepared using a preheated grill. The hamburgers were cooked for 1 minute at each site and subsequently packed in aluminum foil and transferred to a steam oven at 200° C. and relative humidity of 80%. Compositions of the burgers are given in the Table 5 below:

TABLE 5

| Ingredients | Weight in % |
|---|---|
| Texturized vegetable protein | 14 |
| Caramelized sugar ncs 23p from | 0.2 |
| Buisman | |
| Beetroot from Diana | 0.3 |
| Water for hydration of TVP | 32.6 |
| Gellan gum HA (Gellaneer HD ™ from | 0.6 |
| DSM) | |
| Methylcellulose MX | 1.5 |
| Sunflower oil from local brand | 8 |
| Water, ice cold, for the binder | 35 |
| Soy protein isolate, My protein | 3 |
| Salt | 0.7 |
| Maltodextrin | 0.5 |
| Coconut fat | 2 |

### Taste Evaluation of Hamburgers

The burgers were coded blindly and evaluated with a panel (n=4), ranking was performed by grading each attribute between 0 and 10, the two hamburgers with the commercially obtained TVP were taken along. The taste was evaluated on (i) beany, (ii) pea like, (iii) astringency and (iv) rapeseed like.

Results are shown in FIG. 5. Addition of calcium carbonate was beneficial for taste evaluation when 2% calcium carbonate was added, hamburgers were experienced as less rapeseed/pea like. Astringency experience and beany seemed not effected.

1. A process for preparing a texturized vegetable protein comprising:
(a) mixing rapeseed protein, legume-derived protein, from 0.1 to 10% (w/w) calcium carbonate and from 5-30% (w/w) water in an extruder,
heating the mixture obtained in (a) to a temperature of from 100-180° C. in an extruder,
(c) extruding the mixture obtained in (b) through an extrusion die.

2. The Process according to claim 1, wherein (a) further comprises mixing a plant-based fiber, optionally mixing from 5 to 30% (w/w) plant-based fiber, of the weight of the mixture.

3. The Process according to claim 1, wherein the legume-derived protein is chosen from the group consisting of pea protein, fava bean protein, lupin protein and soy protein.

4. The Process according to claim 1, wherein the calcium carbonate has a particle size comprising 35% of the particles have a size of <2 μm, optionally 45% of the particles have a size of <2 μm.

5. The Process according to claim 1, wherein said rapeseed protein is rapeseed protein isolate and/or rapeseed protein concentrate and/or wherein said legume-derived protein is legume-derived protein isolate and/or legume-derived protein concentrate or legume-derived protein enriched flour.

6. The Process according to claim 1, wherein (a) comprises mixing from 10 to 30% (w/w) rapeseed protein and from 50 to 90% (w/w) legume-derived protein, of the weight of the mixture.

7. A composition comprising rapeseed protein, legume-derived protein and from 0.1 to 5% (w/w) calcium based on the weight of the composition, optionally further comprising from 10 to 30% (w/w) rapeseed protein and from 50 to 90% (w/w) legume-derived protein based on the weight of the composition.

8. The Composition according to claim 7, further comprising a plant-based fiber, optionally from 5 to 30% (w/w) plant-based fiber based on the weight of the composition.

9. The Composition according to claim 7, which has a hydration time which is at least 10% shorter than a comparable composition without from 0.1 to 5% (w/w) calcium.

10. The Composition according to claim 7, which has a water holding capacity of at least 10% higher than a comparable composition without from 0.1 to 5% (w/w) calcium.

11. The Composition according to claim 7, which has a density of at least 10% lower than a comparable composition without from 0.1 to 5% (w/w) calcium.

12. The Composition according to claim 7, wherein said legume-derived protein is chosen from the group consisting of pea protein, fava protein, lupin protein and soy protein.

13. A composition according to claim 7 for preparation of a meat alternative, optionally wherein said meat alternative is a hamburger-style patty, a nugget, (“meat”) ball, minced-style product, (stir-fry) piece, or a sausage.

14. A meat alternative comprising the composition of claim 7, optionally wherein the meat alternative is hamburger-style patty, a nugget, (“meat”) ball, minced-style product, (stir-fry) piece or a sausage.

15. A product comprising calcium carbonate for improving the hydration rate, water holding capacity and/or density of a texturized vegetable protein comprising rapeseed protein.
